(19) United States
(12) Patent Application Publication
(10) Pub. No.: US 2022/0133086 A1
(43) Pub. Date: May 5, 2022

(54) Portable Modular Oven

(71) Applicant: Byron Keith Elliott, Johnson City, TN (US)

(72) Inventor: Byron Keith Elliott, Johnson City, TN (US)

(21) Appl. No.: 17/090,828

(22) Filed: Nov. 5, 2020

(51) Int. Cl. A47J 37/06

(52) U.S. Cl. CPC A47J 37/0658; A47J 37/0664

(57) ABSTRACT

A ceramic wood-fired portable pizza oven includes a lower fire chamber and an upper cooking chamber. Heat and smoke of the fire in the lower chamber is transferred through a rear wall vent into the upper chamber, travels over the food, and exits through a front opening. Vents on either side of the lower chamber increase air flow. The ceramic material absorbs and retains the convective heat. The oven temperature can exceed 900 degrees F. to cook a pizza in minutes. The lower chamber has an optional floor to protect the underlying medium. The top of the upper chamber may be removed to convert to a wood-fired griddle and to facilitate cleaning of the cooking surface. The oven may be used outside on noncombustible surfaces or inside a vented fireplace. The unit is easily disassembled to facilitate portability. The oven is designed to be used at home, camping, or tailgating.

### FIELD

This invention relates to the field of ovens for cooking food. More particularly, this invention relates to a portable modular wood-fired oven.

### BACKGROUND

Conventional wood-fired ovens for cooking pizza and baking bread are typically constructed from brick and masonry cement, and are therefore very heavy and bulky. Although such ovens can be constructed on a trailer or bed of a truck to enhance transportability, the bulkiness of such ovens and their transport means significantly limits the locations in which they can be used. No conventional pizza ovens that use campfire logs for fuel are light enough to be easily transported to a variety of locales and be converted to a cooking griddle.

What is needed, therefore, is a compact, lightweight, and portable wood-fired oven that can be easily transported and used in small spaces with adequate ventilation.

### SUMMARY

The above and other needs are met by a modular oven that includes a base portion, a middle portion, a removable upper portion, a cooking chamber, and a fire chamber. In one preferred embodiment, the middle portion includes opposed left and right side panels, a rear panel, and a cooking surface panel. The left and right side panels each have a rear edge and an upper edge. The rear panel has left and right edges and an upper edge, wherein the left and right edges are attached to the rear edges of the left and right side panels. The cooking surface panel is horizontally attached between the left and right side panels, and is vertically offset below the upper edges of the rear panel and the left and right side panels. A passageway is disposed between the rear panel and a rear edge of the cooking surface panel. The removable upper portion is configured to removably engage the upper edge of the rear panel and the upper edges of the left and right side panels of the middle portion. The cooking chamber is disposed between the cooking surface panel and the upper portion. The fire chamber is disposed below the cooking surface panel and between the left and right side panels of the middle portion, such that smoke and heat generated in the fire chamber pass through the passageway into the cooking chamber.

In some embodiments, the base portion of the modular oven is configured to removably engage a lower edge of the rear panel and lower edges of the left and right side panels of the middle portion.

In some embodiments, the upper portion includes a plurality of tabs that extend downwardly from a bottom surface of the upper portion to removably engage the upper edges of the left side panel, right side panel, and rear panel.

In some embodiments, the upper portion includes a lip that extends downwardly from a left edge, a right edge, and a rear edge of the bottom surface of the upper portion, and the plurality of tabs extend downwardly from the lip.

In some embodiments, the middle portion includes a plurality of slots disposed in the upper edges of the rear panel and the left and right side panels, and the plurality of tabs of the upper portion engage the plurality of slots in the upper edge of the rear panel and the upper edges of the left and right side panels when the upper portion engages the middle portion.

In some embodiments, one or more vents are disposed adjacent a lower edge of the left side panel, right side panel, and rear panel of the middle portion.

In some embodiments, the oven includes a removable grill attachment that is configured to removably engage the upper edges of the rear panel and the left and right side panels.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a front perspective view of a modular oven according to an embodiment of the invention;

FIG. 2 depicts a rear perspective view of the modular oven according to an embodiment of the invention;

FIG. 3 depicts a front elevation view of the modular oven according to an embodiment of the invention;

FIG. 4 depicts a right side elevation view of the modular oven according to an embodiment of the invention;

FIG. 5 depicts a left side elevation view of the modular oven according to an embodiment of the invention;

FIG. 6 depicts a rear elevation view of the modular oven according to an embodiment of the invention;

FIG. 7 depicts an exploded front perspective view of the modular oven according to an embodiment of the invention; and

FIG. 8 depicts optional griddle and grill attachments for the modular oven according to an embodiment of the invention.

### DETAILED DESCRIPTION

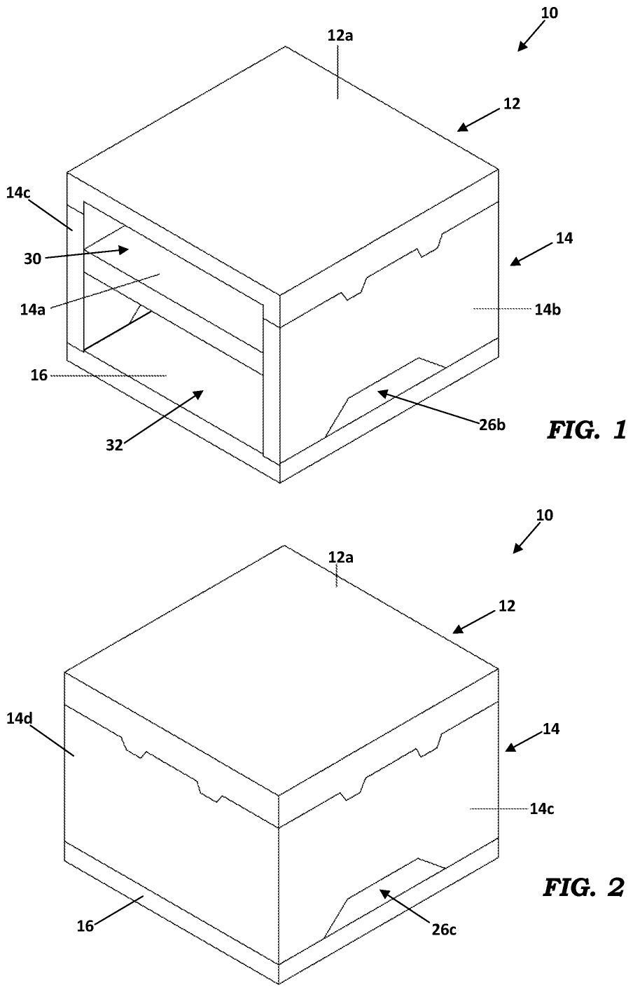

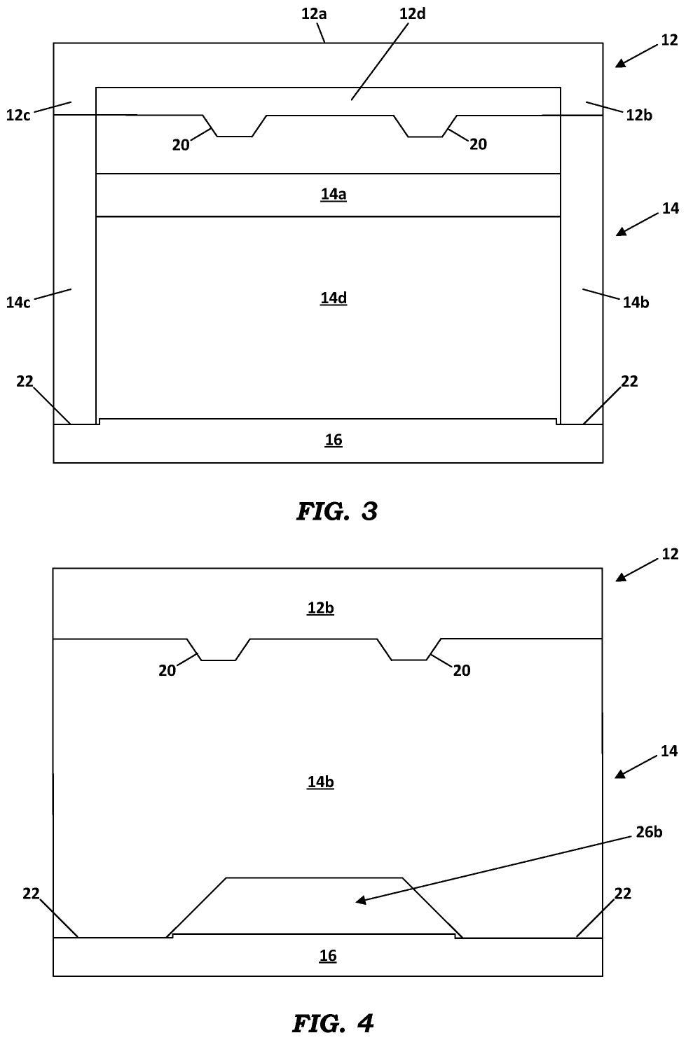

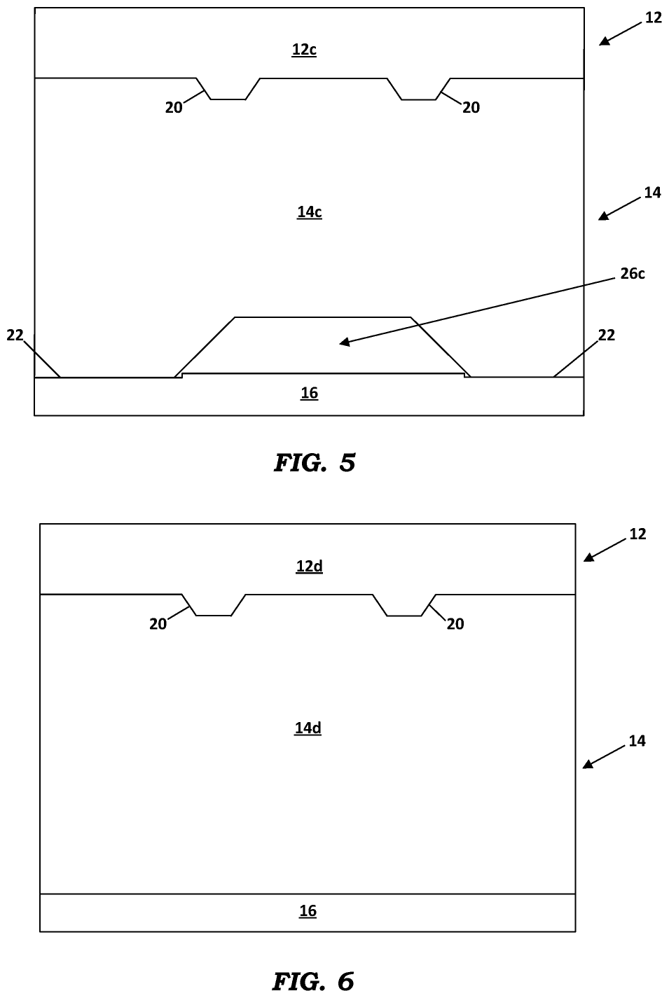

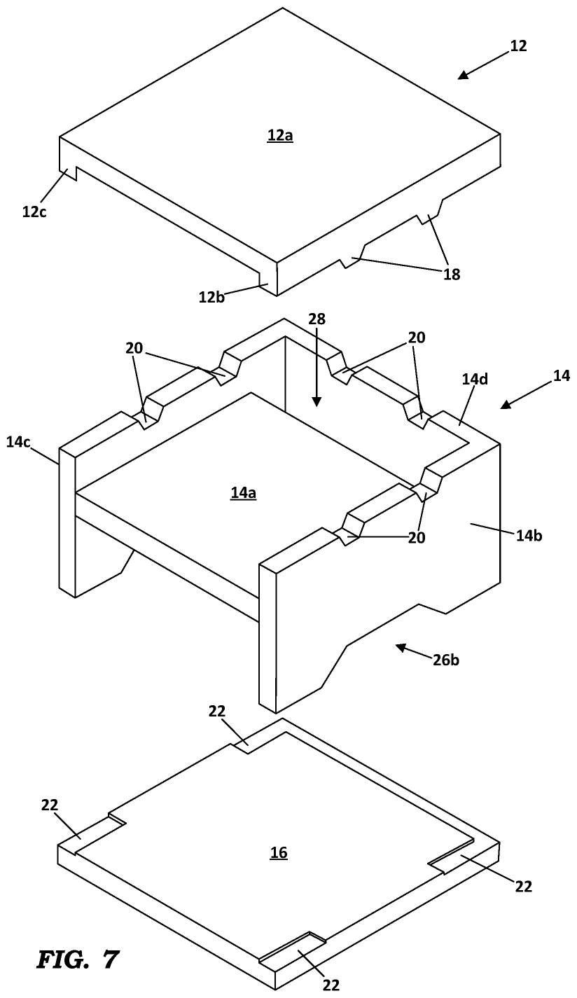

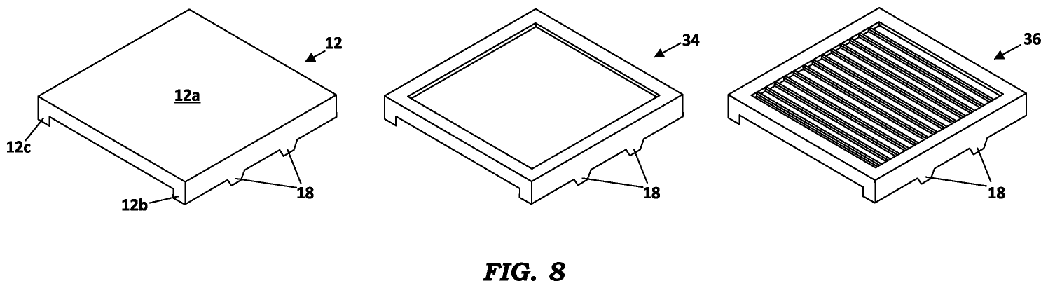

As shown in FIGS. 1-7, a preferred embodiment of a wood-fired oven 10 comprises three modular components, including an upper portion 12, a middle portion 14, and a base portion 16. Each of portions is preferably constructed from a ceramic material. As described in more detail below, the modular components may be disassembled for ease of transport and storage, and reassembled in a few easy steps when the oven is to be put in use.

The base portion 16 is preferably a rectangular horizontal panel having a depth of about 19½ inches, a width of about 15¾ inches, and a thickness of about 1½ inches, with inset regions 22 for receiving the lower edges of the middle portion 14.

The middle portion 14 preferably comprises four generally rectangular panels, including a horizontal cooking surface panel 14a, vertical side panels 14b and 14c, and a vertical rear panel 14d. The cooking surface panel 14a is preferably a rectangular plate having a depth of about 16 inches, a width of about 16 inches, and a thickness of about 1½ inches. The side panels 14b-14c are preferably rectangular plates, each having a height of about 10½ inches, a width of about 19½ inches, and a thickness of about 1½ inches. The rear vertical edges of the side panels 14b-14c are attached to the vertical edges of the rear panel 14d, and the left and right edges of the cooking surface panel 14a are attached to the inner surfaces of the side panels 14b-14c at a height of about 7 inches above the lower edges of the side panels 14b-14c. As shown in FIG. 1, a passageway 28 is provided between the rear panel 14d and the rear edge of the cooking surface panel 14a.

In one embodiment, the edges of the side panels 14b-14c, rear panel 14d, and cooking surface panel 14a are permanently attached together using fasteners or adhesive.

In another embodiment, the side panels 14b-14c, rear panel 14d, and cooking surface panel 14a are removably attached to one another, such as using removable pins, dovetail joints, or mortice and tenon joints. In this manner, the individual panels may be broken down and stacked flatly together for storage and transport.

In yet another embodiment, the side panels 14b-14c, rear panel 14d, and cooking surface panel 14a are integrally formed as a one-piece unit, such as in a molding process.

The upper edges of the side panels 14b-14c and the rear panel 14d preferably include multiple slots 20 that are engaged by corresponding tabs 18 on the upper portion 12, as described in more detail hereinafter.

The upper portion 12 preferably comprises a rectangular upper panel 12a and lip portions 12b, 12c, and 12d that extend downwardly from the upper panel 12a at its right side, left side, and rear edges. The height of the lip portions 12b-12d is about 2½ inches, and each lip portion includes multiple downwardly-extending tabs 18 that are about ¾ inches in height.

The oven 10 is assembled by placing the upper portion 12 on top of the middle portion with the tabs 18 of the upper portion 12 aligned with the slots 20 in the middle portion 14, and placing the middle portion 14 on top of the base portion 16 with the lower edges of the middle portion 14 aligned with the inset regions 22 in the upper surface of the base portion 16. When the three components 12, 14, and 16 are so assembled as shown in FIG. 1, they form a cooking chamber 30 and a fire chamber 32. The cooking chamber 30 is in fluid communication with the fire chamber 32 via the passageway 28, so that smoke from the fire in the fire chamber 32 is drawn into the cooking chamber 30 and over the food cooking therein.

A preferred embodiment of the oven 10 includes vents 26b and 26c in the lower edges of the side panels 14b and 14c of the middle portion 14. The vents 26b and 26c allow air to be drawn into the fire chamber 32 to promote the flow of oxygen to the fire.

In a preferred embodiment, the assembled oven 10 has a total width of about 19 inches, a total depth of about 19½ inches, and a total height of about 14½ inches. At this size, it can easily fit within the fireboxes of most residential fireplaces.

It will be appreciated that particular dimensions are provided above to describe a preferred embodiment of the oven. Such exemplary dimensions do not limit the scope of the invention, as other dimensions may be used in other embodiments.

It should be noted that the base portion 16 may not be necessary in some situations, such as when the oven 10 is used inside the firebox of a fireplace, or on any other fireproof/firesafe surface. In such situations, the overall height of the oven may be reduced by the thickness of the base portion 16. This may be important when using the oven 10 in fireplaces having shorter fireboxes.

In one embodiment depicted in FIG. 8, the upper portion 12 of the oven 10 may be removed and replaced with a griddle attachment 34 or grill attachment 36, each of which preferably includes tabs 18 on the underside that engage the slots 20 in the upper edges of the middle portion 14. In this manner, the heat and smoke from the fire chamber 32 may be used for grilling meats or vegetables on the grill attachment 36, or for cooking pancakes, French toast, or eggs on the griddle attachment 34.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A modular oven comprising:
a middle portion comprising:
opposed left and right side panels, each having a rear edge and an upper edge;
a rear panel having left and right edges and an upper edge, the left and right edges of the rear panel attached to the rear edges of the left and right side panels;
a cooking surface panel that is horizontally attached between the left and right side panels, and vertically offset below the upper edges of the rear panel and the left and right side panels; and
a passageway disposed between the rear panel and a rear edge of the cooking surface panel;
a removable upper portion configured to removably engage the upper edge of the rear panel and the upper edges of the left and right side panels of the middle portion;
a cooking chamber disposed between the cooking surface panel and the upper portion; and
a fire chamber disposed below the cooking surface panel and between the left and right side panels of the middle portion, such that smoke and heat generated in the fire chamber pass through the passageway into the cooking chamber.

2. The modular oven of claim 1 further comprising a removable base portion configured to removably engage a lower edge of the rear panel and lower edges of the left and right side panels of the middle portion.

3. The modular oven of claim 1 wherein the upper portion includes a plurality of tabs that extend downwardly from a bottom surface of the upper portion to removably engage the upper edges of one or more of the left side panel, right side panel, and rear panel.

4. The modular oven of claim 3 wherein the upper portion includes a lip that extends downwardly from a left edge, a right edge, and a rear edge of the bottom surface of the upper portion, and the plurality of tabs extend downwardly from the lip.

5. The modular oven of claim 3 wherein the middle portion includes a plurality of slots disposed in the upper edges of the rear panel and the left and right side panels, and wherein the plurality of tabs of the upper portion engage the plurality of slots in the upper edge of the rear panel and the upper edges of the left and right side panels when the upper portion engages the middle portion.

6. The modular oven of claim 1 further comprising one or more vents disposed adjacent a lower edge of one or more of the left side panel, right side panel, and rear panel of the middle portion.

7. The modular oven of claim 1 further comprising a removable grill attachment configured to removably engage the upper edges of the rear panel and the left and right side panels.

8. A modular oven comprising:
a middle portion comprising:
opposed left and right side panels, each having a rear edge and an upper edge, wherein the upper edge has one or more slots disposed therein;
a rear panel having left and right edges and an upper edge with one or more slots disposed therein, the left and right edges of the rear panel attached to the corresponding rear edges of the left and right side panels;
a cooking surface panel that is horizontally attached between the left and right side panels, and is vertically offset below the upper edges of the rear panel and the left and right side panels; and
a passageway disposed between the rear panel and a rear edge of the cooking surface panel;
a removable upper portion configured to removably engage the upper edge of the rear panel and the upper edges of the left and right side panels of the middle portion, the upper portion including:
a bottom surface having a left edge, a right edge, and a rear edge;
a lip that extends downwardly from the bottom surface; and
a plurality of tabs that extend downwardly from the lip and engage the one or more slots disposed in the upper edge of the rear panel and the upper edges of the left and right side panels;
a removable base portion comprising a bottom panel configured to removably engage a lower edge of the rear panel and lower edges of the left and right side panels of the middle portion;
a cooking chamber disposed between the cooking surface panel and the bottom surface of the upper portion; and
a fire chamber disposed between the cooking surface panel and the bottom panel of the base portion, such that smoke and heat generated in the fire chamber pass through the passageway into the cooking chamber.

9. The modular oven of claim 8 further comprising one or more vents disposed adjacent the lower edge of one or more of the left side panel, right side panel, and rear panel of the middle portion.

10. The modular oven of claim 8 further comprising a removable grill attachment configured to removably engage the upper edges of the rear panel and the left and right side panels.
